(19) United States
(12) Patent Application Publication
(10) Pub. No.: US 2011/0308667 A1
(43) Pub. Date: Dec. 22, 2011

(54) Canning Funnel

(76) Inventor: Mark Gallegos, Clearfield, UT (US)

(21) Appl. No.: 12/820,702

(22) Filed: Jun. 22, 2010

(51) Int. Cl. B65B 39/00; B23P 11/00

(52) U.S. Cl. 141/340; 29/460

(57) ABSTRACT

A canning funnel may comprise a funnel portion; the funnel portion may comprise a conical mouth portion, and a stem portion, and an annular ring, in which the stem portion and annular ring define a channel, and in which the channel is configured to fit a plurality of diameters of container openings.

### BACKGROUND

Ever since the development of canning in the late 1700's many individuals have found it beneficial to make and preserve their own foodstuffs as a means of storing them for future consumption. Many benefits exist for the canner in doing this, however there are several problems encountered during the canning process.

Home bottling, specifically, has proved to be especially difficult if the bottler does not know exactly how the process should be performed. Specifically, a novice bottler may not know or remember to wipe off the lip of a bottle before he or she places the bottle in a pressure cooker or canner. If this is not done, food may get stuck in between the bottle's lid and the bottle creating a bad seal. A bad seal may lead to the introduction or growth of microorganisms within the canned food which may then endanger the end consumer's health when the canned items are eventually consumed. Even if the home bottler does remember to wipe off the lips of the bottle, the cleanup may still be inadequate and the food may spoil before it is consumed. Although the home bottler may have sufficiently cleaned off the lip of the bottle, extra time will have been spent during the process.

Additionally, a typical home bottler does not simply bottle one container-worth of food, but instead may bottle tens if not hundreds of bottles of any one type of food in various sizes of bottles. The home bottler is therefore required to engage in the tedious task of moving from one container to another filling each one. The bottler then places anywhere from six to ten bottles at a time in a pressure cooker. Leaks and spills are commonplace and only add additional cleanup time throughout the process.

In filling the bottles, the home bottler must direct the contents to be bottled into the jar or container in a manner that prevents spillage of the contents to as minimum of a degree as possible. As discussed above, this must also be done while not contaminating the lip of the jar. If a funnel is used, then the home bottler will have to make sure that the funnel does not tip over or out of the bottle while the preserves are being poured into the jar.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of the canning funnel, according to one exemplary embodiment of the principles described herein.

FIG. 2 is top view of the canning funnel of FIG. 1, according to one exemplary embodiment of the principles described herein.

FIG. 3 is a cross-sectional side view of the canning funnel taken along line A of FIG. 2, according to one exemplary embodiment of the principles described herein.

FIG. 4 is a cross-sectional side view of the canning funnel taken along line A of FIG. 2 in relation to a container, according to one exemplary embodiment of the principles described herein.

FIG. 5 is a cross-sectional side view of the canning funnel taken along line A of FIG. 2 in relation to another container, according to one exemplary embodiment of the principles described herein.

FIG. 6 is a cross-sectional side view of the canning funnel taken along line A of FIG. 2 further comprising a number of seats within the channel, according to one exemplary embodiment of the principles described herein.

FIG. 7 is a cross-sectional side view of the canning funnel taken along line A of FIG. 2 further comprising a stabilization arm, according to one exemplary embodiment of the principles described herein.

FIG. 8 is a cross-sectional side view of the canning funnel taken along line A of FIG. 2 further comprising a stabilization arm in relation to a container, according to one exemplary embodiment of the principles described herein.

FIG. 9 is a flowchart illustrating an exemplary method of forming a funnel, according to one exemplary embodiment of the principles described herein.

Throughout the drawings, identical reference numbers designate similar, but not necessarily identical, elements.

### DETAILED DESCRIPTION

Various systems and methods for filling a canning bottle are disclosed herein. The funnel is used to prevent any spills that may occur during the filling process as well as to allow the home bottler to more easily place the processed food inside the bottle. Through the use of the canning funnel, introduction of any microorganisms into the preserved food may be mitigated or prevented entirely. Additionally, the funnel may speed up the process of canning, making it easier and more enjoyable for the home bottler to preserve food. In one embodiment, the funnel is configured to be selectively coupled to containers with openings of various sizes; specifically, industry standard wide mouth bottles (having a lip diameter of approximately 3⅛ inches or 8 cm) and regular mouth bottles (having a lip diameter of approximately 2.5 inches or 6.35 cm).

As used in the present specification and the appended claims, the term “bottle” is meant to be understood broadly as any container which may be used to preserve any number of types of foods for extended periods of times. Generally, a mason-type jar is used in the home for home canning, but it may be appreciated by one skilled in the art that the present funnel may be used on any type of container. Additionally, it can be appreciated that a bottle used in preserving food may be configured to hold any volume of food. For instance, a bottle used in connection with the present exemplary canning funnel may be able to hold a volumetric range of material from 1 cup (236.500 ml) to 1 gallon (3.785 L).

Additionally, as used in the present specification and the appended claims, the term “canner” is meant to be understood broadly as any person who is engaged in canning, bottling, or otherwise preserving food. Indeed, the term “home canner,” “home bottler,” “bottler,” or “user” may all be used to describe a similar person.

Food processing and home bottling is a difficult but rewarding task to undertake. Most bottlers, despite the work involved, enjoy preserving their recipes for future consumption. Generally, the process starts out with the home bottler gathering together the food to be bottled. The food may most certainly come from a home garden, but may also be purchased at a store by the bottler. If further processing is required, then the home bottler prepares the food via a number of methods including freezing, mixing, heating, blanching, and pureeing, among others. This food processing step usually takes up a significant amount of time and any time saving steps available are employed to the home bottler's advantage.

After the food has been processed, the home bottler is then required to sterilize his or her workspace and instruments. More importantly, however, is the sterilization of the bottles, cans, or jars which the home bottler is intending to use. As mentioned above, introduction of any contaminant may lead to sickness or even death when the canned food items are stored away.

After the food has been processed, the home bottler next places the food into the jars and seals them by placing a lid on the bottle and cooking the bottles in a pressure cooker. The heat from the pressure cooker simultaneously seals and pasteurizes the food inside the bottle. After the bottles have cooled, the home bottler is then required to check each lid to see if a proper seal has been made. This is done by pressing down on the lid to see if it springs back, tapping the lid in order to check for a dull sound, or checking visually whether or not the lid is concave.

Everything leading up to placing the bottles in the pressure cooker may drastically effect whether or not the bottle will seal. It is usually during the filling step when most of the mistakes can be made, as discussed above.

The problems associated with filling the bottles are greatly multiplied when various types of bottles are used. Generally, canning bottles have been standardized in the industry to two sizes: wide mouth (having a lip diameter of approximately 3.125 inches or 8 cm) and regular mouth (having a lip diameter of approximately 2.5 inches or 6.35 cm) bottles. Despite this industry standardization, however, a home bottler is not necessarily prevented from using other types of bottles. As a result of the different sizes and numbers of bottles available, the user may have a hard time moving from one bottle to another when introducing the food into the bottles. Especially when a funnel is used, the user often finds himself or herself fumbling around with the funnel causing more of a mess than would have been necessary.

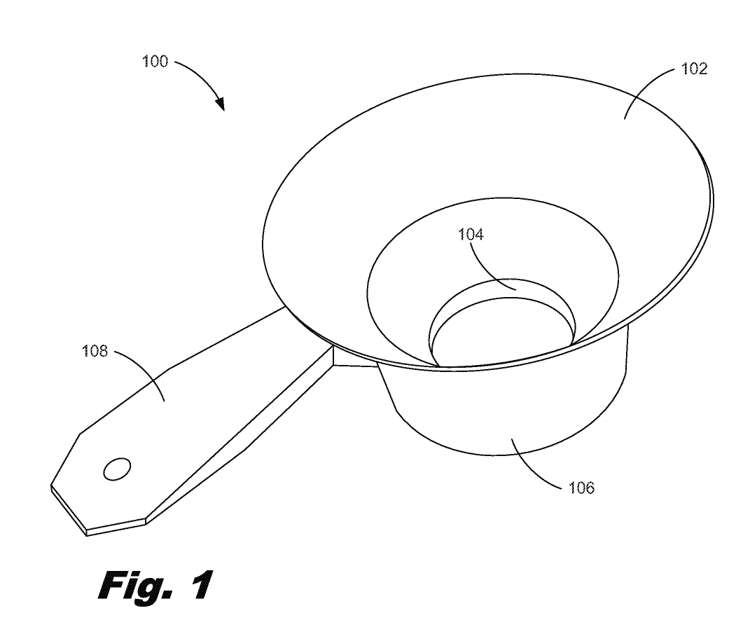

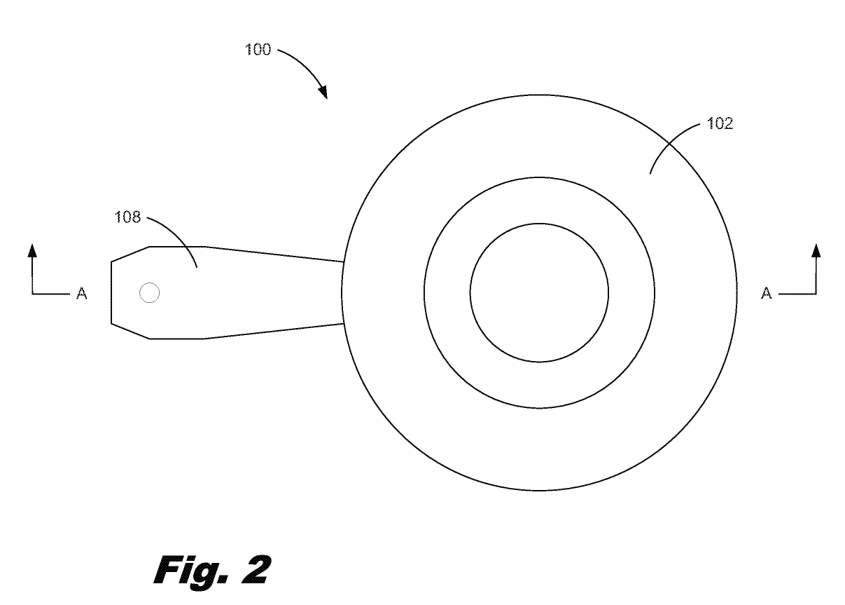

A canning funnel and method of its use will now be discussed in connection with the Figures. FIGS. 1 and 2 are a perspective and top views respectively of a canning funnel (100), according to principles described herein. The canning funnel (100) may comprise a conical mouth portion (102), a stem portion (104), an annular ring (106) and a handle (108). Each of these elements will now be described in more detail below. It may be appreciated that each of the above elements may be made of a stain resistant or non-staining material such as polypropylene, stainless steel, or any other material approved by the Food and Drug Administration (FDA) for use in connection with foodstuffs and food preparation.

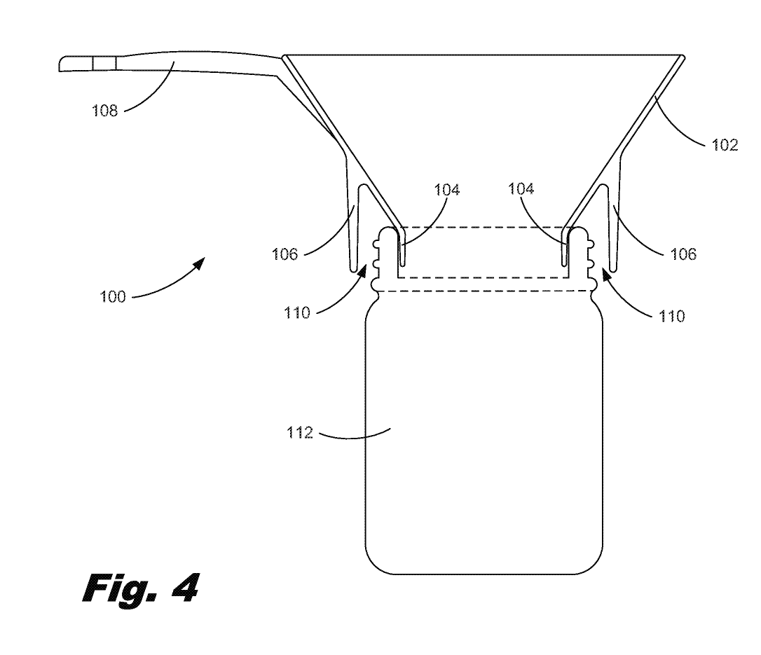

The conical mouth portion (102) may be made of any resilient material such as plastic or metal which generally will allow any type of food going through it to flow downward towards the stem portion (104) of the canning funnel (100) and eventually into the bottle (FIGS. 4, 5 and 7; 112, 114). In one embodiment, the mouth portion (102), along with the stem portion (104), annular ring (106), and handle (108) may be made of polypropylene and may be formed by injecting heated polypropylene into a mold and allowing it to cool. This method is commonly referred to as injection molding. However, it can be appreciated by one skilled in the art that several different methods of molding may be implemented such as blow molding and injection-stretch blow molding. The use of polypropylene may advantageously reduce manufacturing costs while still providing a resilient material for use as a canning funnel (100).

In another embodiment, the mouth portion (102), along with the stem portion (104), annular ring (106), and handle (108) may be made of a metal such as stainless steel. This may provide the canning funnel (100) with a resistance to staining and rusting. In yet another embodiment, the mouth portion (102) and stem portion (104) at least may be covered with a layer of polytetrafluoroethylene or any other non-stick coating thereby allowing the food to more easily slip through the funnel and into the bottle (FIGS. 4, 5 and 7; 112, 114). The use of polytetrafluoroethylene may also be advantageous to the home bottler due to the ease of cleanup involved. Polytetrafluoroethylene is a non-stick coating sold by DUPONT™ under the trademark TEFLON®.

In one embodiment, the opening or top of the mouth portion (102) of the canning funnel (100) may have an internal diameter of between 1 and 10 inches (25.4 mm and 254 mm). In another embodiment, the opening or top of the mouth portion (102) of the canning funnel (100) may have an internal diameter of between 4 and 6 inches (101.6 mm and 152.4 mm). In yet another embodiment, the opening or top of the mouth portion (102) of the canning funnel (100) may have an internal diameter of 5 inches (127 mm). In any case, it may be appreciated that the opening or top of the mouth portion (102) of the canning funnel (100) may have an internal diameter which may fit the purpose for which the canning funnel (100) is to be used.

The depth of the mouth portion (102) may also be varied depending on the type of food being placed in the bottles (FIGS. 4, 5 and 7; 112, 114). In one embodiment, the depth may be between 1 and 3 inches (2.54 and 7.62 cm). In another embodiment, the depth may be 1.8 inches (4.572 cm). Generally a deeper mouth portion (102) of the funnel may prevent any splattering material from leaving the canning funnel (100) and/or bottle (FIGS. 4, 5 and 7; 112, 114).

The stem portion (104) may be made of any resilient material; polypropylene being one example. Additionally, as mentioned above, the stem portion (104) may be made of a metal such as stainless steel and may be further coated with a non-stick coating such as polytetrafluoroethylene.

In the case where the stem portion (104) is made of polypropylene, it, along with the mouth portion (102), the annular ring (106), and the handle (108) may be formed via injection molding. However, where the stem portion (104) is made of metal such as stainless steel, the mouth portion (102) may be coupled to the stem portion (104) via, for example, gluing, welding, riveting, or via a number of screws or a number of bolts and nuts, or other fasteners. In one embodiment, the mouth portion (102) and stem portion (104) of the canning funnel (100) are constructed as one piece simultaneously via casting or press forming.

The diameter of the stem portion (104) is related to the diameter of the bottom of the mouth portion (102). Specifically, the diameter of the bottom of the mouth portion (102) defines the diameter of the top of the stem portion (104). This is because the stem portion (104) is coupled to the mouth portion (102) at the bottom of the mouth portion (102). In one embodiment, the walls of the stem portion (104) are relatively vertical. However, vertical walls on the stem portion (104) are not necessarily required and it may be appreciated that a number of configurations are possible when interfacing the canning funnel (100) with a bottle (FIGS. 4, 5 and 7; 112, 114).

The canning funnel (100) is designed to prevent food from contaminating the lip of the bottle (FIGS. 4, 5 and 7; 112, 114), and therefore the diameter of at least the bottom portion of the stem portion (104) is configured to fit within the bottle (FIGS. 4, 5 and 7; 112, 114). Therefore, the diameter of the stem portion (104) may be slightly smaller than the diameter of the bottle (FIGS. 4, 5 and 7; 112, 114). In one exemplary embodiment, the diameter of the stem portion (104) is configured to fit within a bottle (FIGS. 4, 5 and 7; 112, 114) with a lip diameter of between 2.25 and 2.75 inches (5.715 cm and 6.985 cm respectively). In another exemplary embodiment, the diameter of the stem portion (104) is configured to fit within a bottle (FIGS. 4, 5 and 7; 112, 114) with a lip diameter of 2.5 inches (6.35 cm). As mentioned briefly above, a bottle (FIG. 4; 112) with a lip diameter of 2.5 inches is the standard lip diameter size for a regular size mouth mason jar. However, it can be appreciated by one skilled in the art that the diameter of the stem portion (104) may be configured to fit within the lip of any size of bottle.

The depth of the stem portion (104) may also be varied. In one embodiment, the depth may be between .01 and .1 inches (0.0254 and 0.254). In another embodiment, the depth may be 0.056 inches (0.142 cm). Generally the depth of the stem portion (104) should not be too shallow so as not be able to created sufficient friction between the exterior of the stem portion (104) and the bottle (FIGS. 4, 5 and 7; 112, 114) and thereby allow the canning funnel (100) to rest on the bottle (FIGS. 4, 5 and 7; 112, 114) without the canning funnel (100) falling.

In one embodiment, the stem portion (104) may be tapered towards the bottom of the stem portion (104) so as to prevent food from dripping off of the canning funnel (100) and onto the lip of the bottle (FIGS. 4, 5 and 7; 112, 114) contaminating the lip. This may occur when the funnel is being passed from one bottle (FIGS. 4, 5 and 7; 112, 114) to another during filling of the bottles. As mentioned earlier, contamination of the lip of the bottle (FIGS. 4, 5 and 7; 112, 114) may cause the bottle to not seal properly thereby allowing the food to spoil. Additionally, contamination may require the home bottler to spend additional time wiping off the lips of each bottle, adding to the canning time.

The canning funnel (100) further comprises an annular ring (106) which is attached to the outside wall of the canning funnel (100). The walls of the annular ring (106) are relatively vertical and extend downward from the canning funnel (100). The annular ring (106), like the stem portion (104) and mouth portion (102) above, may be made of any resilient material; polypropylene being one example. Therefore, in one embodiment, the annular ring (106), along with the stem portion (104), mouth portion (102), and handle (108) may be formed by injection molding.

Additionally, as mentioned above, in one embodiment the annular ring (106) may be made of a metal such as stainless steel. The annular ring (106) may then be coupled to the canning funnel (100) via, for example, gluing, welding, riveting, or via a number of screws or a number of bolts and nuts, or other fasteners.

Furthermore, the diameter of the annular ring (106) may be configured to be slightly larger than that of the lip of a canning bottle (FIGS. 4, 5 and 7; 112, 114). This diameter is dependent on the range of bottle lip diameters for which the canning funnel (100) is intended to be used with. Specifically, the lip diameter of the annular ring (106) may be slightly larger than the lip diameter of an industry standard wide mouth mason jar: approximately 3⅛ inches or 8 cm. However, it can be appreciated by one skilled in the art that the lip diameter of the annular ring (106) may be configured to fit the outer circumference of the lip of any size of bottle.

As mentioned above, the stem portion (104) may by configured to fit within an industry standard regular size mouth jar (FIGS. 4, 5 and 7; 112, 114) (having a lip diameter of approximately 3⅛ inches or 8 cm), and the annular ring (106) may be configured to fit the outer circumference of an industry standard wide mouth jar (having a lip diameter of approximately 3⅛ inches or 8 cm). Thus, the channel (110) created by the annular ring (106) and stem portion (104) of the canning funnel (100) is configured to accommodate for both an industry standard regular size mouth jar an industry standard wide mouth jar. This will be discussed with more detail below.

The handle (108) may be attached to the mouth portion (102) of the canning funnel (100) along its exterior circumference. Again, the handle (108), like the stem portion (104), annular ring (106) and mouth portion (102) above, may be made of any resilient material; polypropylene being one example. Therefore, in one embodiment, the handle (108), along with the stem portion (104), mouth portion (102), and annular ring (106) may be formed by injection molding. Additionally, in one embodiment the handle (108) may be made of a metal such as stainless steel. The handle (108) may then be coupled to the canning funnel (100) via, for example, gluing, welding, riveting, or via a number of screws or a number of bolts and nuts, or other fasteners.

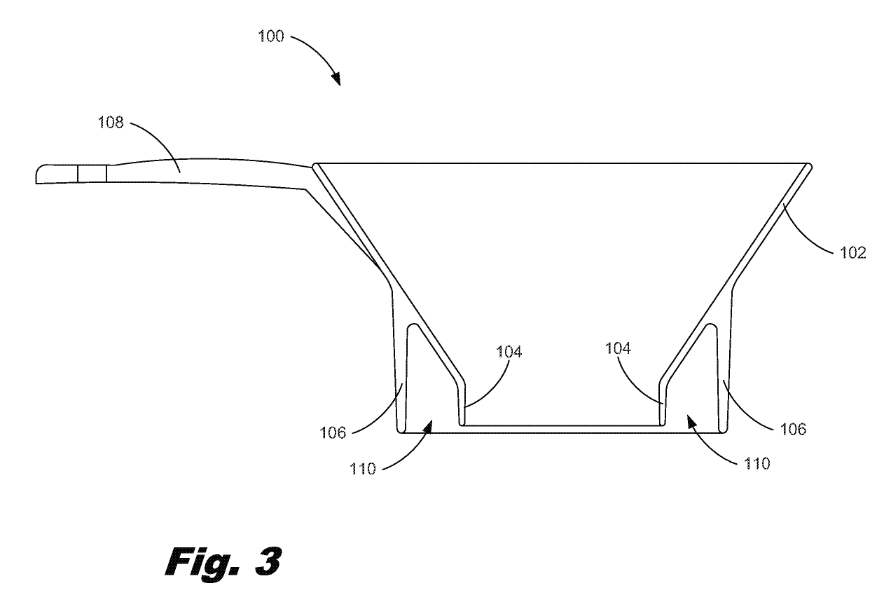

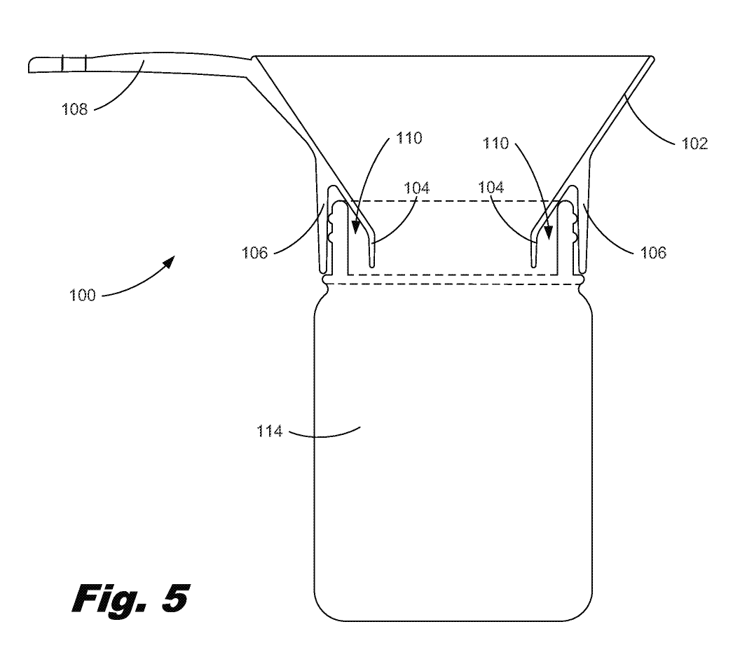

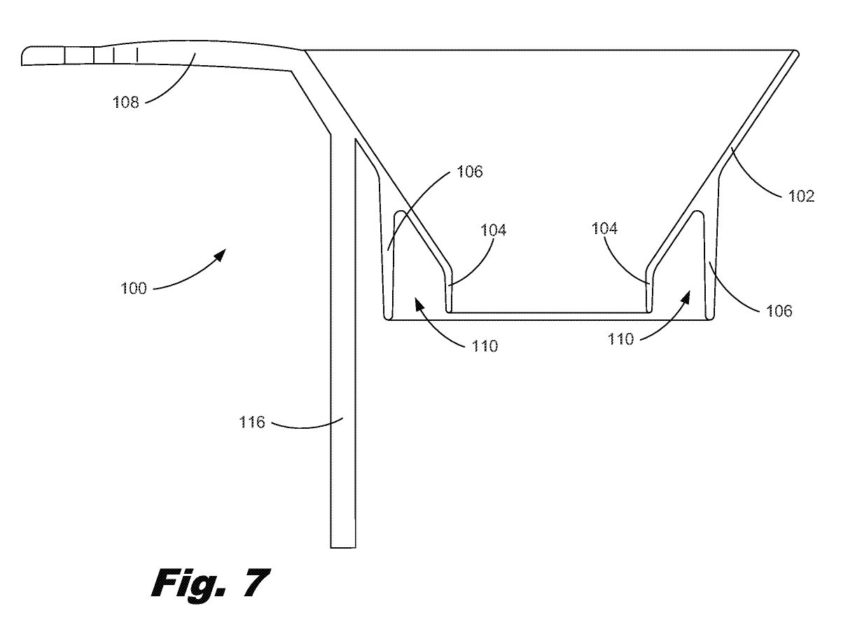

Further specifics regarding the canning funnel (100) will now be addressed with reference to FIGS. 3, 4 and 5. FIG. 3 is a cross-sectional side view taken along line A of FIG. 2. Additionally, FIG. 4 is a cross-sectional side view taken along line A of FIG. 2 and includes a container: specifically a regular mouth bottle (FIGS. 4, 112). Finally, FIG. 5 is a cross-sectional side view taken along line A of FIG. 2 and includes a container: specifically a wide mouth bottle (FIGS. 5 and 7; 114).

As can be seen in FIG. 3, the annular ring (106) and stem portion (104) together create a channel (110). The channel (110) is meant to receive a plurality of different diameters of bottle openings (FIGS. 4, 5 and 7; 112, 114). Therefore, when the home bottler is filling a number of bottles (FIGS. 4, 5 and 7; 112, 114) during the canning process, the canning funnel (100) may be used to fill any bottle (FIGS. 4, 5 and 7; 112, 114) size regardless of the lip diameter of each bottle (FIGS. 4, 5 and 7; 112, 114).

In one exemplary embodiment, the channel (110) may be configured to accommodate any number of known diameters of bottles (FIGS. 4, 5 and 7; 112, 114). In another exemplary embodiment, the channel (100) may be configured to accommodate at least two different diameters of bottles (FIGS. 4, 5 and 7; 112, 114). In yet another exemplary embodiment, the channel (100) may be configured to accommodate the industry standard wide mouth (having a lip diameter of approximately 3.125 inches or 8 cm) and regular mouth (having a lip diameter of approximately 2.5 inches or 6.35 cm) bottles. These embodiments will now be discussed in more detail below.

Additionally, the handle (108) of the canning funnel (100) is configured to be weighted in such a way so that the canning funnel (100) will not fall off or out of the bottle (FIGS. 4, 5 and 7; 112, 114) when the canning funnel (100) is placed on the bottle (FIGS. 4, 5 and 7; 112, 114). Specifically, in one embodiment, the handle (108) and canning funnel (100) are constructed and weighted so as to place the center of mass of the canning funnel (100) at the connection point of the handle (108) and mouth portion (102) of the canning funnel (100). Alternatively, the handle (108) and canning funnel (100) are constructed and weighted so as to place the center of mass of the canning funnel (100) directly over the center of the mouth portion (102). This is done so that any weight from the handle (108) will not pull the canning funnel (100) off of the bottle (FIGS. 4, 5 and 7; 112, 114). This, in turn, ensures a greater degree of stability hen using the canning funnel (100).

Additionally, the handle (108) is left relatively short so that the home bottler will be less likely to bump the handle (108) and thereby cause the canning funnel (100) to fall off or out of the bottle (FIGS. 4, 5 and 7; 112, 114). In one embodiment, the length of the handle (108) may be between 2 to 6 inches (5.08 to 15.24 cm). In another embodiment, the length of the handle (108) may be 4 inches (10.16 cm).

Turning now to FIG. 4, the canning funnel (100) has been placed on a regular mouth bottle (FIGS. 4; 112). As mentioned above, per the industry standards a regular mouth bottle has a lip diameter of 2.5 inches (6.35 cm). Therefore, the lip diameter of the stem portion (104) is configured to be slightly smaller so that the stem portion (104) may fit within the lip of the regular mouth bottle (112). When the canning funnel (100) is placed in the bottle (112), the lip of the bottle (112) touches both the stem portion (104) and mouth portion (102) of the canning funnel (100) and is allowed to rest on top of the bottle (112).

In one embodiment, the exterior wall of the stem portion (104) is coated with a coating having a relatively high coefficient of friction such as rubber. The stem portion (104) is coated with rubber so as to not allow the canning funnel (100) to be pulled or pushed off of the bottle (FIGS. 4, 5 and 7; 112, 114) while the home bottler is filling the bottle (FIGS. 4, 5 and 7; 112, 114). However, the coating may not have a friction coefficient so high so as to not allow the home bottler to easily remove the canning funnel (100) from one bottle and place it on another. Additionally, the lip diameter of the stem portion (104) should not be too large so as to increase the coefficient of friction of the coating against the bottle (FIGS. 4, 5 and 7; 112, 114).

As can be seen in FIG. 4, the channel (110) is configured to receive a number of different lip sizes of bottles (FIGS. 4, 5 and 7; 112, 114). FIG. 5 additionally shows the canning funnel (100) engaged with a different size of bottle. Specifically, bottle (114) has a larger lip diameter than the bottle (112) shown in FIG. 4. As mentioned previously, the canning funnel (100) is meant to fit a plurality of lip sizes found on any number of bottles: FIG. 4 depicting the canning funnel (100) fitting an industry standard sized regular mouth mason jar and FIG. 5 depicting the canning funnel (100) fitting an industry standard sized wide mouth mason jar. In both FIGS. 4 and 5, it can be seen that the bottles' (FIGS. 4, 5 and 7; 112, 114) lips do not occupy the full span of the channel (110). This is done so that a home bottler may, while filling the jars, place the canning funnel (100) over any size of bottle (FIGS. 4, 5 and 7; 112, 114) without having to use two or more specialized sizes of funnels.

As can be further seen in FIG. 5, the wide mouth jar, with a lip diameter of approximately 3.125 inches (8 cm), abuts the interior side of the annular ring (106). The annular ring (106) is therefore configured to stabilize the canning funnel (100) while the canning funnel (100) is engaged with the bottle (114).

Additionally, the lip of the bottle (114) is below or exterior to the mouth portion (102) of the canning funnel (100) and therefore any food being placed into the canning funnel (100) will not be able to come in contact with the lip of the bottle (114). This is beneficial to the user because the canning funnel (100) ensures that the lip of the bottle (FIGS. 4, 5 and 7; 112, 114) does not become contaminated with food. In this manner, the user will not have to clean the lip of the bottle (FIGS. 4, 5 and 7; 112, 114) prior to placing it in the pressure cooker.

Similar to the stem portion (104) above, the interior surface of the annular ring (106) may be coated with a coating having a relatively high friction coefficient such as rubber. The interior portion of the annular ring (106) may be coated with rubber so as to not allow the canning funnel (100) to be pulled or pushed off of the bottle (FIGS. 4, 5 and 7; 112, 114) while the home bottler is filling the bottle (FIGS. 4, 5 and 7; 112, 114). However, the coating should not have a friction coefficient so high so as to not allow the home bottler to easily remove the canning funnel (100) from one bottle and place it on another. Additionally, the lip diameter of the annular ring (106) should not be too small so as to increase the coefficient of friction of the coating against the bottle (FIGS. 4, 5 and 7; 112, 114).

It may be appreciated that the span of the channel (110) formed by the annular ring (106) and stem portion (104) may vary in size depending on the variance in lip diameters of the bottles (FIGS. 4, 5 and 7; 112, 114) intended to be used by the home bottler. Specifically, the interior of the annular ring (106) may define the largest lip size of bottles (FIGS. 4, 5 and 7; 112, 114) for which the canning funnel (100) may be used. Conversely, the exterior of the stem portion (104) may define the smallest lip size of bottles (FIGS. 4, 5 and 7; 112, 114) for which the canning funnel (100) may be used.

In one embodiment, the canning funnel (100) may further comprise any additional number of annular rings (106) each defining an interior and exterior lip diameter for which a maximum lip sized and minimum lip sized bottle may be used. Each annular ring (106) would then be coated with a coating having a relatively high friction coefficient similar to the annular ring (106) described above.

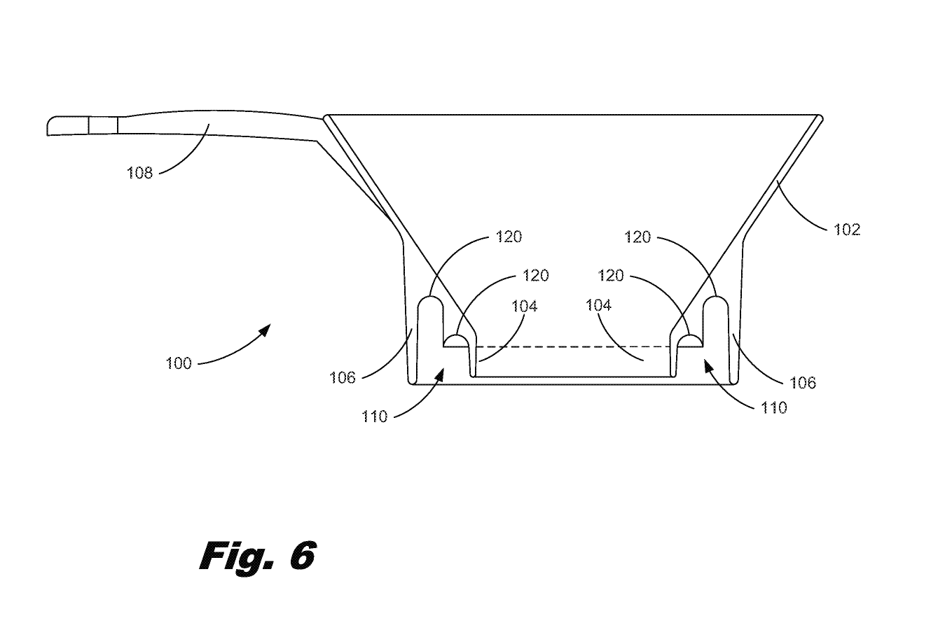

Turning now to FIG. 6, a cross-sectional side view taken along line A of FIG. 2 is shown further including a number of seats (120) within the channel (110). Similar to the mouth portion (102), stem portion (104), annular ring (106), and handle (108), the seats (120) may be made of polypropylene and formed within the channel (110) via injection molding. The seats (120) are generally concave and form a counter lip over a bottle (FIGS. 4, 5 and 7; 112, 114).

The seats (120) are therefore configured to receive the lip of certain sizes of bottles (FIGS. 4, 5 and 7; 112, 114) and adds additional stability to the canning funnel (100) when the canning funnel (100) is engaged with any lip size of bottle (FIGS. 4, 5 and 7; 112, 114). It may be appreciated that any number of seats (120) may be formed within the channel (110) so as to accommodate any number of different lip sized bottles (FIGS. 4, 5 and 7; 112, 114). Similar to the stem portion (104) and interior surface of the annular ring (106) above, the seats (120) may also be coated with a coating having a relatively high friction coefficient such as rubber.

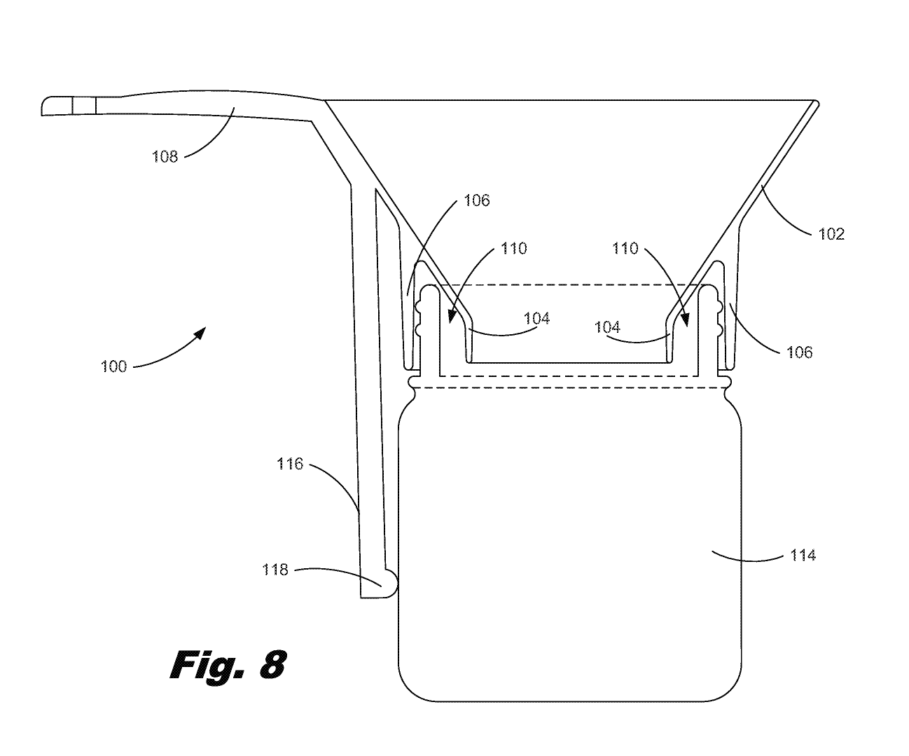

Turning now to FIGS. 7 and 8, the canning funnel (100) may further include a stabilization arm (116) coupled to the exterior of the mouth portion (102) of the canning funnel (100). The stabilization arm (116) is configured to add additional stabilization to the canning funnel (100) when the canning funnel (100) is engaged with a bottle (FIGS. 4, 5 and 7; 112, 114).

In one embodiment, the stabilization arm (116) is made of a resilient material such as polypropylene and may be formed along with the mouth portion (102), stem portion (104), annular ring (106), handle (108), and/or seats (120) during the injection molding process. In another embodiment, the stabilization arm (116) is configured to be slightly bent and/or biased towards the center of the canning funnel (100) so as to apply pressure to the exterior of the bottle (FIGS. 4, 5 and 7; 112, 114) regardless of the size of the bottle (FIGS. 4, 5 and 7; 112, 114).

As depicted in FIG. 8, the stabilization arm (116) may additionally comprise a stabilization arm nub (118) configured to abut the bottle (FIGS. 4, 5 and 7; 112, 114) and apply pressure against it. This is done so as to add additional stabilization to the canning funnel (100) when the canning funnel (100) is engaged with the bottle (FIGS. 4, 5 and 7; 112, 114).

The stabilization arm (116) in either FIG. 7 or 8 may be sufficiently long enough to be able to come in contact with the bottle (FIGS. 4, 5 and 7; 112, 114). In one embodiment, the length of the stabilization arm (116) is between 2 and 8 inches (5.08 and 20.32 cm). In another embodiment, the stabilization arm (116) is 5 inches (12.7 cm) long. However, it can be appreciated that the stabilization arm (116) may be long enough to at least be able to come in contact with the bottle (FIGS. 4, 5 and 7; 112, 114).

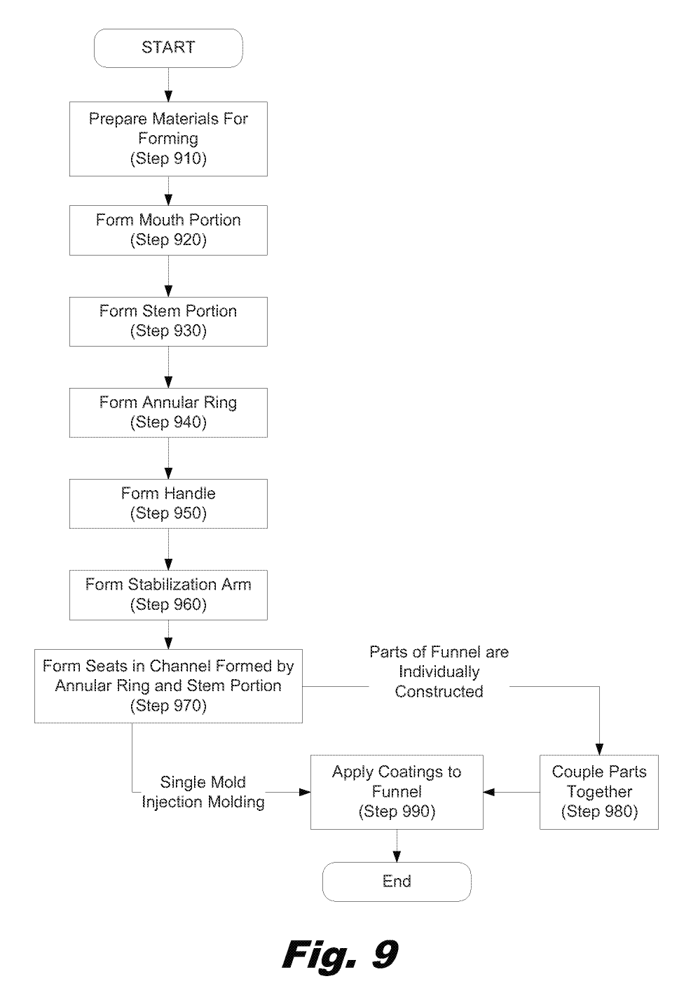

Turning now to FIG. 9, a flowchart illustrating an exemplary method of forming a funnel according to an embodiment of the present exemplary system and method is shown. The method begins by preparing the materials for form (step 910). The method of preparing the materials will vary depending on the type of materials used.

For instance, when polypropylene is used to form the various parts of the canning funnel (100), the polypropylene in its raw form is provided in granules form. The polypropylene granules are then fed into a heating apparatus where the granules are melted down. The melted polypropylene is then forced into mold cavities which represent the specific item being formed. In one exemplary embodiment all parts of the canning funnel (100) including the mouth portion (102), stem portion (104), annular ring (106), handle (108), seats (120), and stabilization arm (116) may be formed via one mold during the injection molding process. However, this is not necessary and one skilled in the art can appreciate that each part of the canning funnel (100) may be formed in different molds and then assembled later.

When the mold used in the injection molding process is a complete representation of all of the parts of the canning funnel (100), then when the melted polypropylene is extruded into the mold cavity, the polypropylene is left to cool before it is ejected out of the mold. Therefore, Steps 920, 930, 940, 950, 960, and 970 are all completed in one step, namely a single injection molding.

However, where a number of mold cavities are used which represent individual parts of the canning funnel (100), polypropylene is injected into each mold representing each part of the canning funnel (100) and again left to cool before it is ejected. Then each part is coupled appropriately together via, for example, gluing, welding, riveting, or via a number of screws or a number of bolts and nuts, or other fasteners until a completed canning funnel (100) is made.

As described above, in forming the handle (108) (Step 940) and the rest of the canning funnel (100) (Steps, 920, 930, 940, 960, 970) the handle may be formed such that the combination of the handle, annular ring, conical mouth portion, and stem portion have a center of mass positioned at the connection point of the handle and conical mouth portion of the canning funnel

In the case where other materials such as stainless steel are used, a sheet of stainless steel may be sent through a cutting press where individual pieces of the canning funnel (100) are cut out and refined. Therefore, each piece of the canning funnel (100), including the mouth portion (102), the stem portion (104), the annular ring (106), the handle (108), the seats (120), and the stabilization arm (116) are each individually cut out of a piece of stainless steel. The individual pieces are then subjected to a number of other manufacturing processes such as trimming, grinding and polishing.

After each part of the canning funnel (100) has been processed and refined, they are then coupled together (step 980) to form a single canning funnel (100). The individual parts are coupled appropriately together via, for example, gluing, welding, riveting, or via a number of screws or a number of bolts and nuts, or other fasteners.

In each instance, the canning funnel (100) with all of its parts may further be refined to include the various coatings as described above (step 990). For instance, as described above the interior surface of the mouth portion (102) and stem portion (104) may be coated with a layer of polytetrafluoroethylene or other non-stick coating. Additionally, the interior section of the annular ring (106) and exterior section of the stem portion (104) may be coated with a coating having a relatively high friction coefficient such as rubber.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A canning funnel comprising:
a funnel portion, the funnel portion comprising:
a conical mouth portion; and
a stem portion, and
an annular ring,
in which the stem portion and annular ring define a channel; and
in which the channel is configured to fit a plurality of diameters of container openings.

2. The canning funnel of claim 1, further comprising a handle coupled to the funnel portion.

3. The canning funnel of claim 2, in which the handle has a mass such that the center of mass of the canning funnel is positioned at the connection point of the handle and conical mouth portion of the funnel portion, or over the center of the conical mouth portion of the funnel portion.

4. The canning funnel of claim 1, in which at least a portion of the interior surface of the funnel portion is coated with a non-stick coating.

5. The canning funnel of claim 1, in which the channel further comprises a plurality of seats into which a plurality of diameters of container openings engage.

6. The canning funnel of claim 1, in which the canning funnel further comprises a stabilization arm coupled to the exterior of the funnel portion in which the stabilization arm is configured to abut the container.

7. The canning funnel of claim 1, in which the stem portion has an exterior diameter of 2.5 inches.

8. The canning funnel of claim 1, in which the annular ring has an interior diameter of 3.125 inches.

9. A canning funnel comprising:
a funnel portion;
an annular ring disposed on the exterior of the funnel in which a lip of a container is received in between the exterior of the funnel portion and the interior of the annular ring; and
a stabilization arm coupled to the exterior of the funnel portion and configured to abut the container.

10. The canning funnel of claim 9, further comprising a handle coupled to the funnel portion.

11. The canning funnel of claim 10, in which the handle has a mass such that the center of mass of the canning funnel is positioned at the connection point of the handle and a conical mouth portion of the funnel portion, or over the center of the conical mouth portion of the funnel portion.

12. The canning funnel of claim 9, in which the interior surface of the funnel portion is coated with a non-stick coating.

13. The canning funnel of claim 9, in which the channel further comprises a plurality of seats into which a plurality of diameters of container openings are configured to fit.

14. The canning funnel of claim 9, in which the funnel portion comprises a stem portion, and in which the stem portion has an exterior diameter of 2.5 inches.

15. The canning funnel of claim 9, in which the annular ring has an interior diameter of 3.125 inches.

16. A method of making a canning funnel, comprising:
forming a funnel comprising a conical mouth portion and a stem portion; and
forming an annular ring on the exterior of the funnel in which the stem portion and annular ring define a channel, and
in which the channel is configured to fit a plurality of diameters of container openings.

17. The method of claim 16, further comprising coating the channel with a coating having a relatively higher coefficient of friction than the material from which the channel is made.

18. The method of claim 16, further comprising forming a plurality of seats between the stem portion of the funnel and the annular ring.

19. The method of claim 16, further comprising coating the interior surface of the funnel with a non stick coating.

20. The method of claim 16, further comprising forming a stabilization arm, and coupling the stabilization arm to the exterior of the funnel.
